(19) United States
(12) Patent Application Publication
(10) Pub. No.: US 2011/0278261 A1
(43) Pub. Date: Nov. 17, 2011

(54) ETCHING ACID WASTE LIQUID DISPOSAL SYSTEM, ETCHING ACID WASTE LIQUID DISPOSAL APPARATUS AND ETCHING ACID WASTE LIQUID DISPOSAL METHOD APPLIED TO THE SYSTEM AND THE APPARATUS

(75) Inventors: Hideki Himi, Toyama-ken (JP); Puchalapalli Sreenivasulu Reddy, Toyama-ken (JP); Masahiro Abe, Kanagawa-ken (JP); Akinori Iso, Kanagawa-ken (JP)

(73) Assignees: SHIBAURA MECHATRONICS CORPORATION, Yokohama-shi (JP); ECOCYCLE CORPORATION, Toyama-shi (JP)

(21) Appl. No.: 13/104,159

(22) Filed: May 10, 2011

(30) Foreign Application Priority Data
May 11, 2010 (JP) 2010-108902

(51) Int. Cl. C23F 1/46; B01D 29/00; B01D 36/00; B01D 15/04

(52) U.S. Cl. 216/93; 210/260; 210/258; 156/345.18

(57) ABSTRACT

According to one embodiment, a solid removal process in a filter and a positive metal ion removal process in a positive metal ion-exchange resin column are performed sequentially through an etching acid waste liquid disposal circulation flow channel, the solid removal process is performed on an upstream side of the positive metal ion removal process, furthermore after the positive metal ion removal process, a negative metal ion removal process removing at least B using a chelate forming fiber or a chelate forming resin is performed on a downstream side of the etching acid waste liquid disposal circulation flow channel, thereby an etching acid waste liquid is recycled sequentially through the etching acid waste liquid disposal circulation flow channel.

### CROSS-REFERENCE TO RELATED APPLICATIONS

This application is based upon and claims the benefit of priority from the prior Japanese Patent Application No. 2010-108902, filed on May 11, 2010; the entire contents of which are incorporated herein by reference.

### FIELD OF THE INVENTION

Embodiments of the present invention described herein relate generally to an etching acid waste liquid disposal system, an etching acid waste liquid disposal apparatus and an etching acid waste liquid disposal method applied to the system and the apparatus.

### BACKGROUND OF THE INVENTION

Previously, in the treatment of chemical etching of a substrate surface used for a semiconductor, liquid crystal or the like, an etching acid including HF, SO₄, NO₃, CH₃COOH and H₃PO₄ or the like as main components has been widely used, the etching acid being mixed acid of hydrogen fluoride (HF) and nitric acid (HNO₃).

In a liquid crystal display device manufactured by using the etching acid like this, scanning lines and signal lines driving a prescribed picture element are often formed of stacked films covering a molybdenum (Mo) monolayer film and an alloy film including molybdenum as a main component and titanium (Ti), chromium (Cr), nickel (Ni), zirconium (Zr), niobium (Nb), hafnium (Hf), tantalum (Ta), tungsten (W) or the like as additional elements, or an aluminum (Al) monolayer film and an alloy film including aluminum as a main component and boron (B), carbon (C), magnesium (Mg), silicon (Si), titanium (Ti), nickel (Ni), copper (Cu), zinc (Zn), yttrium (Y), zirconium (Zr), palladium (Pd), silver (Ag), lanthanum (La), cerium (Ce), neodymium (Nd), tantalum (Ta) or the like as additional elements with an alloy film (so called cap layer and barrier layer) including a molybdenum monolayer film or molybdenum as a main component.

Since an etching waste liquid discharged after an etching process using the etching liquid has negative effects on a person's health and environment, a strict effluent standard is set on its discharge.

Therefore, previously, a filtrate obtained from solid separation is subjected to ion-exchange treatment, and thereby the treatment of removing melted metals is performed before the discharge to an exhaust passage of the waste product.

With regard to the etching acid waste liquid disposal system and the disposal method, JP-A 2005-150171 (Kokai) indicates that in the case where an etching acid for roughening treatment of a surface while rotating the silicon wafer substrate, the etching acid including HF and HNO₃ as components for etching, is used, use of concentrated sulfuric acid (H₂SO₄) with a concentration of 95% or more as a thickener is effective, and is also advantageous from the viewpoint of liquid waste disposal because the concentrated sulfuric acid is the same acid system as the main component of the etching acid.

### SUMMARY OF THE INVENTION

In general, according to one invent, an etching acid waste liquid disposal system (e.g. a system for disposing waste liquid of an etching acid) includes a regenerating mechanism. The regenerating mechanism is configured to regenerate an etching acid waste liquid (e.g. waste liquid of an etching acid) as a regenerated etching acid. The etching acid waste liquid is discharged after using an etching acid for etching. The etching acid regenerated by the regenerating mechanism is recycled for the etching.

Various embodiments will be described hereinafter with reference to the accompanying drawings.

An embodiment can be applied to an etching in a manufacturing process of a semiconductor device, a liquid crystal device, an organic EL device or a field emission type device, and an etching aid can be at least one acid of HF, SO₄, NO₃, CH₃COOH and H₃PO₄, for example, 0.5% DHF or the like, namely HF of 0.5% concentration diluted with ultrapure water. DHF of 0.1 to 1.0% concentration is also available as the etching acid.

An etching acid waste liquid disposal apparatus (e.g. an apparatus for disposing waste liquid of an etching acid) is formed by connecting a filter removing solid to an ion-exchange resin column removing positive metal ion through an etching acid waste liquid disposal circulation flow channel (e.g. a circulation flow channel for disposing waste liquid of an etching acid), and includes a negative metal ion removal unit removing the negative metal ion contained in the etching acid waste liquid.

The positive metal ion removed by the ion-exchange resin column is an ion of titanium (Ti), tantalum (Ta), aluminum (Al), nickel (Ni), cobalt (Co), silver (Ag), gold (Au), copper (Cu) and tungsten (W) used for forming a conductive contact to constituent elements formed in or on an active and a passive element regions or a semiconductor substrate, and used for forming a metal film for connecting the constituent elements and/or regions with interconnections by filling via holes, rnetalizing between layers and forming a pattern with mutual interconnection paths, for example, in a semiconductor manufacturing technology.

The negative metal ion removal unit can be set to remove at least boron (B).

The negative metal ion removal unit may be a chelate forming fiber or a chelate forming resin.

Furthermore, each of the filter and the ion-exchange resin column connected through the etching acid waste liquid disposal circulation flow channel is set to be a sealed vessel and successive connection of the each sealed vessel through the etching acid waste liquid disposal circulation flow channel connecting the each sealed vessel may allow the etching acid waste liquid to flow by a single pump.

An etching acid waste liquid disposal method (e.g. a method for disposing waste liquid of an etching acid) of the embodiment is distinctive in regenerating the etching acid waste liquid discharged after using at least one of HF, SO₄, NO₃, CH₃COOH and H₃PO₄ for etching in the manufacturing process of the semiconductor device, the liquid crystal device, the organic EL device or the field emission type device, and in recycling sequentially for the etching in the manufacturing process of the semiconductor device, the liquid crystal device, the organic EL device or the field emission type device.

In the etching acid waste liquid disposal method of the embodiment, a solid removal process removing a solid by the filter and a positive metal ion removal process removing the positive metal ion are sequentially performed through the etching acid waste liquid disposal circulation flow channel, and thus the method may include a negative metal ion removal process removing the negative metal ion contained in the etching acid waste liquid by contacting the etching acid waste liquid with the chelate forming fiber or the chelate forming resin.

### BRIEF DESCRIPTION OF THE DRAWINGS

FIG. 1 is a schematic view of an etching acid waste liquid disposal system of a first embodiment.

### DETAILED DESCRIPTION OF THE INVENTION

In the etching acid waste liquid disposal system, the etching acid waste liquid disposal apparatus and the etching acid waste liquid disposal method applied to the system and the apparatus, the negative metal ion removal unit removing the negative metal ion is provided, and the etching acid waste liquid is individually disposed and recycled without mixing other waste liquids, and thus waste of the etching acid can be reduced.

The respective sealed vessels are successively connected with the etching acid waste liquid disposal circulation flow channel flowing the etching acid waste liquid and the apparatus is possibly downsized, and thus pressure loss can be suppressed, the operation by one pump and low load operation with low power consumption become possible.

Because the etching acid waste liquid disposal system, the etching acid waste liquid disposal apparatus and the etching acid waste liquid disposal method applied to the system and the apparatus are configured to form of the sealed vessels and additional chemicals are not used, operators having special qualifications are unnecessary and management cost and personnel cost can be set low.

The embodiment will be described hereinafter.

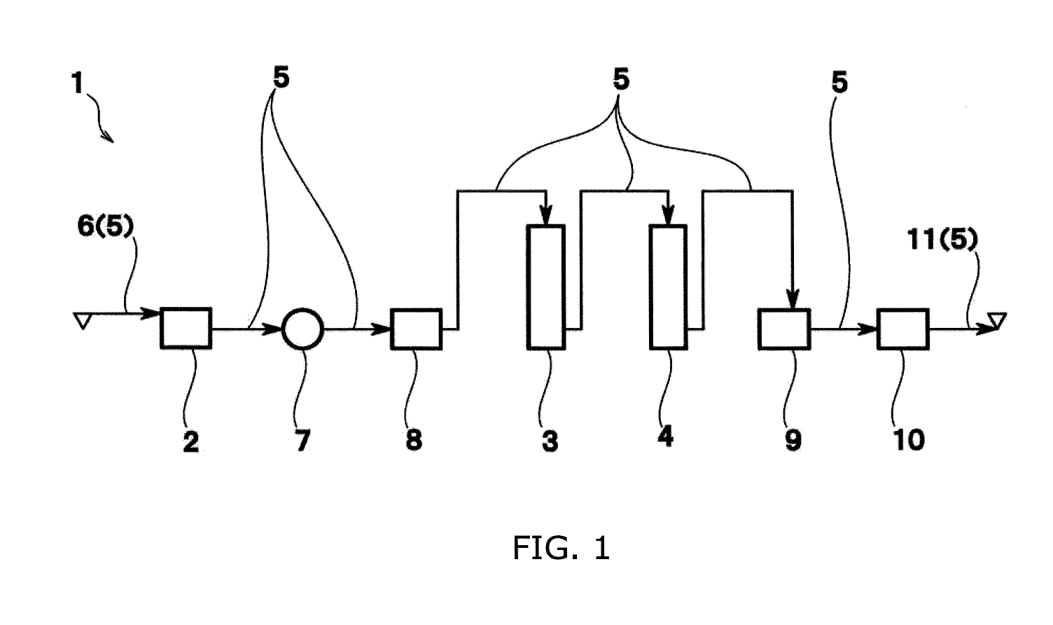

FIG. 1 shows an etching acid waste liquid disposal apparatus 1 of the embodiment of a regenerating mechanism configured to regenerate the etching acid waste liquid discharged after using the etching acid for etching as a regenerated etching acid.

The etching acid waste liquid disposal apparatus 1 is configured to form by connecting a filter 2 removing the solid and an ion-exchange resin column 3 removing the positive metal ios with an etching acid waste liquid disposal circulation flow channel 5 and connecting the filter 2 to an upstream side of the positive metal ion-exchange resin column 3.

The solid contained in the etching acid waste liquid are removed by passing through the filter 2 connected to an input pipe 6 in which the etching acid waste liquid flows, the input pipe being a part of the etching acid waste liquid disposal circulation flow channel 5.

The filter 2 is connected to a pump 7 and a flow meter 8 through the etching acid waste liquid disposal circulation channel 5, and furthermore the ion-exchange resin column 3 is successively connected through the etching acid waste liquid disposal circulation channel 5. Therefore, in the etching acid waste liquid disposal apparatus 1, the etching acid waste liquid passing through the filter 2 is successively supplied to the positive metal ion-exchange resin column 3.

An negative metal ion removal unit 4 removing at least B by the chelate forming fiber or the chelate forming resin is successively connected at a downstream side of the etching acid waste liquid disposal circulation channel 5 of the ion-exchange resin column 3.

The chelate forming resin in which a metal ion and a functional group generating a chelate (complex) is introduced instead of ion-exchange group captures the metal ion by forming the chelate. The chelate forming resin can remove B in a range of 5<pH<14.

The chelate forming fiber is a fiber bonding chemically a metal ion and a chelate agent compound forming the complex to a cellulose fiber. In other words, the chelate forming fiber is a fiber which bonds a chelate agent chemically to a cellulose fiber, and the chelate agent is a compound forming metal ion complex. The chelate agent refers to a compound including multiple elements (N, O, P, S or the like) having lone electron pair in one molecule. Strong chelate bond (coordinate bond) is formed by providing electron of the lone electron pair to the metal ion. The chelate agent called EDTA (ethylenediaminetetraacetic acid) is generally used in industry.

The chelate forming fiber has a chelate functional group on the fiber surface and has a very high contact efficiency with a solution, and thus adsorbs a metal ion and a half-metal ion in the solution quickly. The chelate forming fiber has high performance of low concentration removal, and high reactivity of the chelate functional group of the chelate forming fiber with the metal ion and the half metal-ion, and thus can remove the metal ion and the half-metal ion in the solution to 1 ppb or less. Furthermore, the chelate forming fiber has high selective adsorption characteristic, adsorbs a half-metal such as B selectively and has no influence from co-existing heavy metal, alkali metal and alkaline-earth metal.

In particular, the chelate forming fiber adsorbing B can be used for removing B in a range of 2.5<pH<12, and the chelate forming fiber of the negative metal ion removal unit 4 can remove B in the etching acid waste liquid of pH<5 containing 0.5% DHF.

A favorable functional group of the chelate forming fiber used in the embodiment is illustrated as a functional group of the following general formula [1].

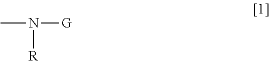

The functional group shown by the general formula [1] is such that nitrogen and hydroxyl group in the functional group have excellent selective capture capability to boron.

The chelate forming fiber in which the chelate forming functional group shown in the general formula [1] is introduced has excellent chelate capture capability to B, and the capture example of boron ion captured by the chelate forming fiber in which an N-methyl-D-glucamine residue is introduced is exemplified in the following formula [2].

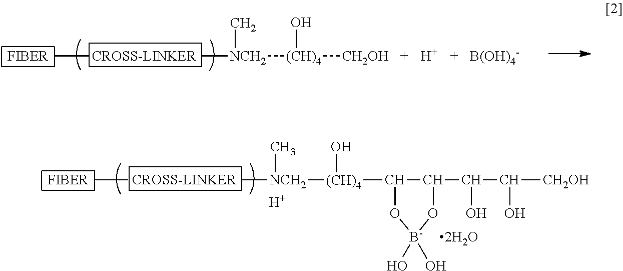

A group having an amino group and two or more hydroxyl groups in a molecule, particularly a group having at least two hydroxyl groups bonded to adjacent carbon, is introduced into the chelate forming fiber, and the chelate forming fiber indicates the excellent capture capability to boron and thus captures boron more effectively.

A particle filter 9 is connected to a downstream side of the etching acid waste liquid disposal circulation flow channel 5 of the negative metal ion removal unit 4, and particles in the etching acid waste liquid are removed. The etching acid waste liquid after disposal is supplied as the etching acid newly supplied to the etching process for recycling via a pH meter 10 measuring pH connected to a further downstream side and through an output pipe 11 being a part of the etching acid waste liquid disposal circulation flow channel 5.

In the etching acid waste liquid disposal apparatus 1, the solid removal process in the filter 2 and the positive metal ion removal process in the positive metal ion-exchange resin column 3 are performed sequentially through the etching acid waste liquid disposal circulation flow channel 5, the solid removal process is performed on the upstream side of the positive metal ion removal process, furthermore after the positive metal ion removal process, the negative metal ion removal process removing at least B using the chelate forming fiber or the chelate forming resin is performed on the downstream side of the etching acid waste liquid disposal circulation flow channel 5, thereby the etching acid waste liquid is recycled successively through the etching acid waste liquid disposal circulation flow channel 5.

The etching acid waste liquid flowing into the etching acid waste liquid disposal apparatus 1 contains B of 100 ppb or more, for example, in the etching process of the liquid crystal substrate, and this is an obstacle to recycling. If the etching acid waste liquid has pH<5, the chelate forming resin cannot adsorb B. However, in the etching acid waste liquid disposal apparatus 1 of the above embodiment, the amount of B can be reduced to less than 1 ppb by performing the negative metal ion removal process removing B using the chelate forming fiber adsorbing B in the range of 2.5<pH<12. Therefore, recycling of the etching acid waste liquid is possible.

In the etching acid waste liquid disposal apparatus 1 of the embodiment shown in FIG. 1, each of the filter 2, the positive metal ion-exchange resin column 3 and the negative metal ion removal unit 4 connected through the etching acid waste liquid disposal circulation flow channel 5 is set to be a sealed vessel and the successive connection of the respective sealed vessels through the etching acid waste liquid disposal circulation flow channel 5 connecting the respective sealed vessels allows the etching acid waste liquid to flow by a single pump 7. Each of the vessels is formed of a sealed vessel made of an alloy or FRP, and by sealing the vessels in that manner, the operation can be performed with ease for everyone.

In the etching acid waste liquid disposal apparatus 1, the solid removal process in the filter 2, the positive metal ion removal process in the positive metal ion-exchange resin column 3 and the negative metal ion removal process in the negative metal ion removal unit 4 are sequentially performed by flowing the etching acid waste liquid through the etching acid waste liquid circulation flow channel 5 by the single pump 7 in the respective vessels. At that time, a driving source other than the pump 7 is unnecessary particularly and the operation by the single pump 7 is possible. Therefore, the whole of the etching acid waste liquid disposal apparatus 1 can be compact and furthermore power consumption can be reduced and low cost etching acid waste liquid disposal can be performed.

Moreover, it is unnecessary to perform the above processes by an operator having special qualifications.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An etching acid waste liquid disposal system comprising:
a regenerating mechanism configured to regenerate an etching acid waste liquid as a regenerated etching acid, the etching acid waste liquid being discharged after using an etching acid for etching,
the etching acid regenerated by the regenerating mechanism being recycled for the etching.

2. The system according to claim 1, wherein the etching is an etching in a manufacturing process for a semiconductor device, a liquid crystal device, an organic EL device or a field emission type device.

3. The system according to claim 1, wherein the etching acid is at least one acid of HF, SO₄, NO₃, CH₃COOH and H₃PO₄.

4. An etching acid waste liquid disposal apparatus comprising:
a filter configured to remove a solid;
an ion-exchange resin column configured to remove a positive metal ion;
an etching acid waste liquid disposal circulation flow channel connecting the filter and the ion-exchange resin column; and
a negative metal ion removal unit configured to remove a negative metal ion contained in an etching acid waste liquid.

5. The apparatus according to claim 4, wherein the filter is provided on an upstream side of the ion-exchange resin column.

6. The apparatus according to claim 4, further comprising a pump,
the filter being connected to the pump through the etching acid waste liquid disposal circulation flow channel.

7. The apparatus according to claim 4, further comprising a flow meter,
the filter being connected to the flow meter via the pump through the etching acid waste liquid disposal circulation flow channel.

8. The apparatus according to claim 4, wherein the positive metal ion is an ion of one of titanium (Ti), tantalum (Ta), aluminum (Al), nickel (Ni), cobalt (Co), silver (Ag), gold (Au), copper (Cu) and tungsten (W).

9. The apparatus according to claim 4, wherein the negative metal ion removal unit removes at least boron (B).

10. The apparatus according to claim 4, wherein the negative metal ion removal unit is provided on a downstream side of the ion-exchange resin column.

11. The apparatus according to claim 4, wherein the negative metal ion removal unit is a chelate forming fiber or a chelate forming resin.

12. The apparatus according to claim 11, wherein the chelate forming fiber is a fiber bonding a chelate agent chemically to a cellulose fiber, and the chelate agent is a compound forming metal ion complex.

13. The apparatus according to claim 11, wherein the chelate forming fiber includes an amino group and two or more hydroxyl groups.

14. The apparatus according to claim 4, wherein a particle filter is further provided on a downstream side of the negative metal ion removal unit.

15. The apparatus according to claim 4, wherein a pH meter configure to measure pH is further provided on a downstream side of the particle filter.

16. The apparatus according to claim 4, wherein each of the filter and the ion-exchange resin column connected through the etching acid waste liquid disposal circulation flow channel is set to be a sealed vessel and successive connection of the each sealed vessel through the etching acid waste liquid disposal circulation flow channel connecting the each sealed vessel allows the etching acid waste liquid to flow by a single pump.

17. An etching acid waste liquid disposal method comprising:
regenerating an etching acid waste liquid discharged after using at least one acid of HF, SO₄, NO₃, CH₃COOH and H₃PO₄ for etching in a manufacturing process of a semiconductor device, a liquid crystal device, an organic EL device or a field emission type device through an etching acid waste liquid disposal circulation flow channel; and
recycling successively for the etching in the manufacturing process of the semiconductor device, the liquid crystal device, the organic EL device or the field emission type device.

18. The method according to claim 17, further comprising:
a solid removal process configured to remove a solid by a filter and a positive metal ion removal process configured to remove a positive metal ion being sequentially performed through the etching acid waste liquid disposal circulation flow channel; and
a negative metal ion removal process configured to remove a negative metal ion contained in the etching acid waste liquid by contacting the etching acid waste liquid with a chelate forming fiber or a chelate forming resin.

19. The method according to claim 18, wherein the positive metal ion is an ion of one of titanium (Ti), tantalum (Ta), aluminum (Al), nickel (Ni), cobalt (Co), silver (Ag), gold (Au), copper (Cu) and tungsten (W).

20. The method according to claim 18, wherein the negative metal ion is at least an ion of boron (B).
